(19) United States
(12) Patent Application Publication
(10) Pub. No.: US 2025/0028622 A1
(43) Pub. Date: Jan. 23, 2025

(54) DYNAMIC DEBUGGER MANAGEMENT HELPER SERVICE

(71) Applicant: INTERNATIONAL BUSINESS MACHINES CORPORATION, Armonk, NY (US)

(72) Inventors: Vipin M V, Palakkad Dist (IN); RAJESH KUMAR JEYAPAUL, BANGALORE (IN); Bipin Chandra, Bengaluru (IN); Devi Priyanka Oruganti, Bangalore (IN); Shivangi Mehra, Gurugram (IN)

(21) Appl. No.: 18/224,279

(22) Filed: Jul. 20, 2023

(51) Int. Cl. G06F 11/34; G06F 11/32

(52) U.S. Cl. CPC G06F 11/3476; G06F 11/323

(57) ABSTRACT

Aspects of the present invention monitor at least one microservice within a container module for a failure; collect logged data in response to the at least one microservice having the failure; check the logged data to determine that an existing tree is not built for the logged data; perform telemetry tracing on the at least one microservice in response to the existing tree not being built for the logged data; collect logged tracing data based on performing the telemetry tracing on the at least one microservice; visualize an actual flow of the collected logged tracing data; and fix the at least one microservice based on the visualized actual flow the collected logged tracing data.

### BACKGROUND

Aspects of the present invention relate generally to a dynamic debugger management helper service and, more particularly, to a dynamic debugger management helper service which improves serviceability in a cloud environment.

In a cloud environment, microservices are included in a container and deployed on a cloud using an orchestration platform. Further, containerization of microservices has improved deployment when transferring an application from a development platform to a deployment platform. Containerization of the microservices has also improved an application development process.

### SUMMARY

In a first aspect of the invention, there is a computer-implemented method including: monitoring, by a processor set, at least one microservice within a container for a failure; collecting, by the processor set, logged data in response to the at least one microservice having the failure; checking, by the processor set, the logged data to determine that an existing tree is not built for the logged data; performing, by the processor set, telemetry tracing on the at least one microservice in response to the existing tree not being built for the logged data; collecting, by the processor set, logged tracing data based on performing the telemetry tracing on the at least one microservice; visualizing, by the processor set, an actual flow of the collected logged tracing data; and fixing, by the processor set, the at least one microservice based on the visualized actual flow of the collected logged tracing data.

In another aspect of the invention, there is a computer program product including one or more computer readable storage media having program instructions collectively stored on the one or more computer readable storage media. The program instructions are executable to: monitor at least one microservice within a container for a failure; collect logged data in response to the at least one microservice having the failure; check the logged data to determine that an existing tree is not built for the logged data; perform telemetry tracing on the at least one microservice in response to the existing tree not being built for the logged data; collect logged tracing data based on performing the telemetry tracing on the at least one microservice; visualize an actual flow of the collected tracing data; and fix the at least one microservice based on the visualized actual flow of the collected logged tracing data.

In another aspect of the invention, there is a system including a processor set, one or more computer readable storage media, and program instructions collectively stored on the one or more computer readable storage media. The program instructions are executable to: monitor at least one microservice within a container for a failure; collect logged data in response to the at least one microservice having the failure; check the logged data to determine that an existing tree is not built for the logged data; perform telemetry tracing on the at least one microservice in response to the existing tree not being built for the logged data; collect logged tracing data based on performing the telemetry tracing on the at least one microservice; visualize an actual flow of the collected logged tracing data; and fix the at least one microservice based on the visualized actual flow of the collected tracing data. The existing tree includes a historical tree which corresponds with a previous failure of a previous microservice.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment of a debugging management server in accordance with aspects of the present invention.

FIG. 3 shows a flowchart of an exemplary method of the debugging management server in accordance with aspects of the present invention.

FIG. 4 shows a block diagram of a log analyzer module in accordance with aspects of the present invention.

FIG. 5 shows a flowchart of an exemplary method of the log analyzer in accordance with aspects of the present invention.

FIG. 6 shows a tree of the log analyzer in accordance with aspects of the present invention.

### DETAILED DESCRIPTION

Aspects of the present invention relate generally to a dynamic debugger management helper service and, more particularly, to a dynamic debugger management helper service which improves serviceability in a cloud environment. Embodiments of the present invention apply an open telemetry tracing to at least one cloud workload so that data is collected and analyzed to determine a root cause of a failure. In particular, embodiments of the present invention improve performance by collecting only data (i.e., a subset of data of at least one microservice) needed to determine the root cause of the failure. Embodiments of the present invention provide a debugger management helper service which is integrated with artificial intelligence for information technology operations (AIOps) to automatically capture data for debugging and testing runtime failures without having to read logs and understand an exception stack from failed nodes. In particular, when an exception (i.e., a failure) happens, embodiments of the present invention analyze an exception stack, determine what data needs to be collected for the exception, and determines a custom code that needs to be executed to determine the root cause of the failure. Embodiments of the present invention determine what data needs to be collected for the exception using an application performance monitoring (APM) tool. Embodiments of the present invention determine a suspected root cause of the failure based on the collected data for the exception of the failure. Embodiments of the present invention also protect the collected data by preventing unauthorized access to source code.

Embodiments of the present invention provide automated data tracing in an optimized environment to determine the suspected root cause of a failure with a low impact on application performance in comparison to conventional AIOps and orchestration platform systems. Conventional AIOps and orchestration platform systems compare a current failure to a history of earlier failures to determine a root cause of the current failure. However, this approach in conventional AIOps and orchestration platform systems does not perform well when there is a functional exception or a logical approach. In this scenario, the conventional AIOps and orchestration platform systems require manual analysis of computer codes and logged errors to determine the root cause. Further, even when using blind tracing in the conventional AIOps and orchestration platform systems, performance suffers and a large amount of effort is required to determine the root cause of a failure from a large amount of data collected by blind tracing. Embodiments of the present invention improve performance by providing a targeted approach to data collection to determine the root cause of a failure. Embodiments of the present invention utilize artificial intelligence (AI) to dynamically build a custom tree from an exception stack. Embodiments of the present invention utilize the custom tree to set telemetry settings for performing telemetry tracing on a container. Embodiments of the present invention determine a root cause for a failure using collected tracing data and fix the failure based on the determined root cause.

Embodiments of the present invention determine a root cause for a failure using telemetry tracing and dynamically built custom trees. Accordingly, implementations of aspects of the present invention provide an improvement (i.e., technical solution) to a problem arising in the technical field of AIOps and orchestration platforms. In particular, embodiments of the present invention dynamically build custom trees using artificial intelligence (AI). Embodiments of the present invention perform targeted telemetry tracing based on the dynamically built custom trees. Also, embodiments of the present invention may not be performed in a human mind because aspects of the present invention include using artificial intelligence (AI) to dynamically build custom trees based on an exception stack. Further, implementations of the present invention improve the functioning of the computer by improving the resiliency of the computer under adverse conditions, such as a functional exception or a logical error.

Implementations of the invention are necessarily rooted in computer technology. For example, the step of dynamically building a custom tree based on an exception stack is computer-based and cannot be performed in the human mind. Training and using an artificial intelligence (AI) model are, by definition, performed by a computer and cannot practically be performed in the human mind (or with pen and paper) due to the complexity and massive amounts of calculations involved. For example, dynamically building a custom tree based on an exception stack requires a large amount of processing of data and modeling of parameters across many recursive iterations of the custom tree to train the model such that the model generates an output (i.e., a complete custom tree) in real time (or near real time). Given the scale and complexity of processing the data and modeling of parameters across many recursive iterations of the custom tree, it is simply not possible for the human mind, or for a person using pen and paper, to perform the number of calculations involved in training and/or using an artificial intelligence (AI) model.

Aspects of the present invention include a method, system, and computer program product for automated extraction of only required traces from a problematic environment with a low impact on performance. For example, a computer-implemented method includes: identifying relevant and suspected stacks through tracking and a code walk through on exception stacks identified from logs; capturing methods involved in the relevant stacks for tracing, the methods being captured using a log analyzer sub system which is configured to identify the methods from the exception stack for tracing; constructing a tree based on the code walk through on stack involvements and forming a knowledge base for subsequent stack involvements; forming open telemetry traces based on the methods; receiving collected data; and visualizing a data flow over a microservices stack to determine a cause of failure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as dynamic debugging service code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

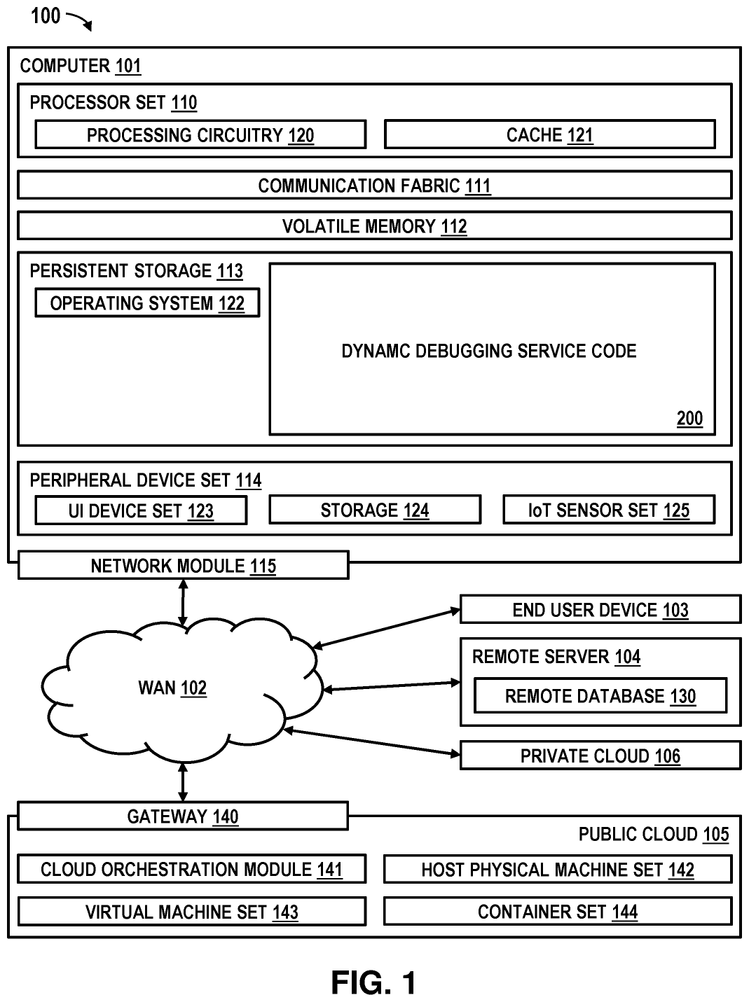

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

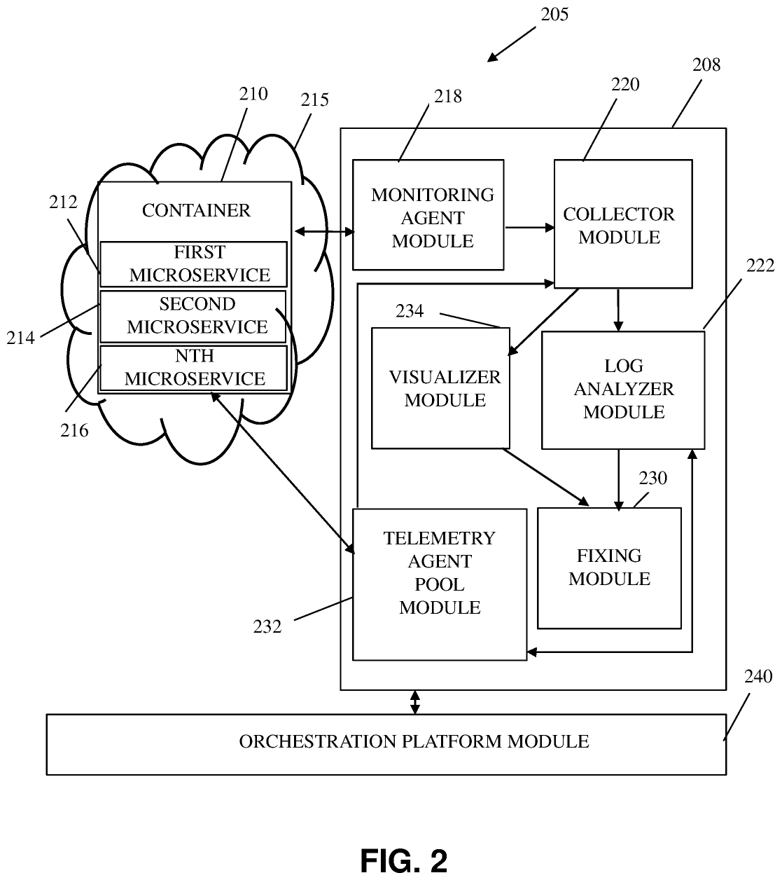

FIG. 2 shows a block diagram of an exemplary environment 205 in accordance with aspects of the present invention. In embodiments, the environment 205 includes a debugging management server 208, which may comprise one or more instances of the computer 101 of FIG. 1. In other examples, the debugging management server 208 comprises one or more virtual machines or one or more containers running on one or more instances of the computer 101 of FIG. 1. In further embodiments, the environment 205 also includes an orchestration platform module 240, which may comprise one or more instances of the remote server 104 of FIG. 1. In other examples, the orchestration platform module 240 comprises one or more virtual machines or one or more containers running one or more instances of the computer 101 of FIG. 1. However, embodiments are not limited, and the environment 205 may only include the debugging management server 208 and not include the orchestration platform module 240. In an example, the orchestration platform module 240 may be any module that is external to the debugging management server 208.

In embodiments, the debugging management server 208 of FIG. 2 comprises a monitoring agent module 218, a collector module 220, a log analyzer module 222, a fixing module 230, a telemetry agent pool module 232, and a visualizer module 234, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In FIG. 2, and in accordance with aspects of the invention, the monitoring agent module 218 communicates with a cloud-based system 215 comprising a container 210 which includes a plurality of microservices (e.g., a first microservice 212, a second microservice 214, . . . , a nth microservice 216). In particular, the monitoring agent module 218 communicates with the container 210 which includes a plurality of microservices (e.g., a first microservice 212) to monitor at least one microservice (e.g., a first microservice 212) of the plurality of microservices. In particular, the monitoring agent module 218 monitors the at least one microservice using an APM tool. However, embodiments are not limited to the APM tool for monitoring the at least one microservice. In FIG. 2, the cloud-based system 215 is external to the debugging management server 208 and includes the container 210 including the plurality of microservices which communicate with the monitoring agent module 218 and the telemetry agent pool module 232.

In an example of the embodiments, the monitoring agent module 218 monitors the at least one microservice and determines that the at least one microservice crashes (i.e., has a failure). In further embodiments, the monitoring agent module 218 communicates with the orchestration platform module 240 in response to a determination that the at least one microservice crashes. In particular, the orchestration platform module 240 determines whether the at least one microservice crashing is similar to a historic failure. In further embodiments, the orchestration platform module 240 applies a similar solution of the historic failure to fix the at least one microservice crashing in response to a determination that the at least one microservice crashing is similar to the historic failure.

In embodiments, the monitoring agent module 218 collects logged data (e.g., exception logged data) in response to a determination that the at least one microservice crashing is not similar to a historic failure. In an example, the at least one microservice crashing is not typically similar to the historic failure when the at least one microservice crashing is a functional or logical error. The monitoring agent module 218 then sends the collected logged data to a collector module 220. The collector module 220 sends the collected logged data to a log analyzer module 222 and a visualizer module 234.

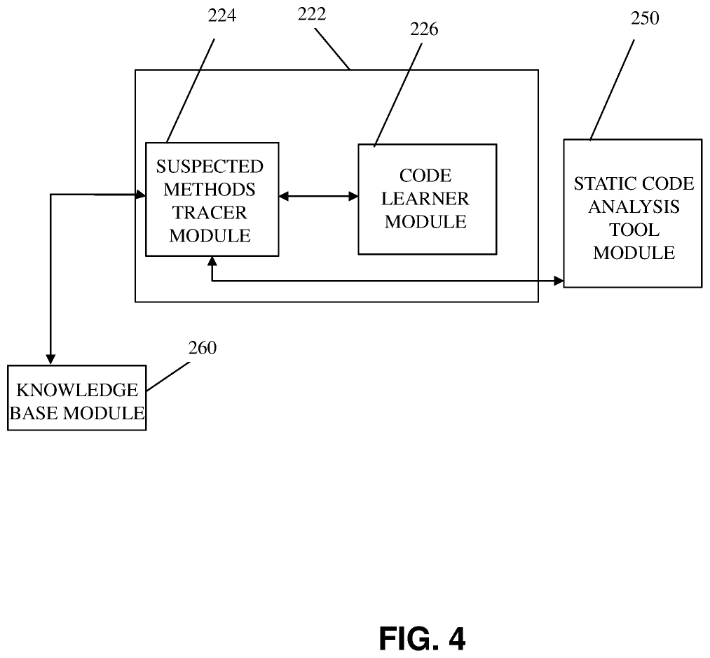

In embodiments, the log analyzer module 222 uses a code learner module 226 (shown in FIG. 4) to walk through an exception stack of the collected logged data and determine if an existing tree from a knowledge base module 260 (shown in FIG. 4) is built for the collected logged data. In embodiments, the existing tree is a historical tree which corresponds with a previous failure of a previous microservice. In embodiments, the log analyzer module 222 communicates with the fixing module 230 to apply a similar fix of the existing tree to the at least one microservice crashing in response to a determination that the existing tree is built for the collected logged data (i.e., the existing tree corresponds with the at least one microservice crashing). The log analyzer module 222 places a request on a suspected methods tracer module 224 (shown in FIG. 4) to build a suspected methods tree using artificial intelligence (AI) in response to a determination that an existing tree is not built for the collected logged data. The log analyzer module 222 also uses the code learner module 226 to determine tracing options which are needed from the telemetry agent pool module 232 for further data collection. In further embodiments, the log analyzer module 222 sends the tracing options which are needed to the telemetry agent pool module 232. Details of the log analyzer module 222, the suspected methods tracer module 224, and the code learner module 226 are described herein with respect to FIG. 4.

Referring back to FIG. 2, in embodiments, the telemetry agent pool module 232 receives the tracing options which are needed from the log analyzer module 222 and sets the tracing options. In particular, the telemetry agent pool module 232 includes at least one telemetry agent which performs telemetry tracing on the container 210 which includes a plurality of microservices (e.g., a first microservice 212) to perform telemetry tracing and collect data on at least one microservice (e.g., a first microservice 212) of the plurality of microservices. In particular, the at least one telemetry agent may comprise a script which gets deployed on demand, at predetermined intervals, or after a failure threshold. The at least one telemetry agent performs telemetry tracing and collects data on the at least one microservice and sends the collected data from the telemetry tracing to the collector module 220. The collector module 220 then sends the collected data from the telemetry tracing to the visualizer module 234.

In embodiments, the visualizer module 234 receives the collected data from the telemetry tracing from the at least one telemetry agent in the telemetry agent pool module 232. In further embodiments, the visualizer module 234 visualizes an actual flow of data through a visualizer user interface (UI) over an exception stack corresponding to the collected data from the telemetry tracing to determine a root cause of the at least one microservice crashing. In particular, the visualizer module 234 visualizes the actual flow of data through the visualizer UI by correlating the actual flow of data over the exception stack corresponding to the collected data in a graphical representation and detecting data going wrong at particular nodes. The visualizer module 234 sends the root cause of the at least one microservice crashing to the fixing module 230.

In embodiments, the fixing module 230 fixes the root cause of the at least one microservice crashing. In particular, the fixing module 230 fixes the root cause of the least one microservice crashing by utilizing at least one of a code change, a configuration change, a work around, etc. The fixing module 230 then sends the root cause of the at least one microservice and the fix to the log analyzer module 222 for saving a tree in the knowledge base module 260 (shown in FIG. 4). Accordingly, the log analyzer module 222 determines if the saved tree from the knowledge base module 260 is built for a future collected logged data.

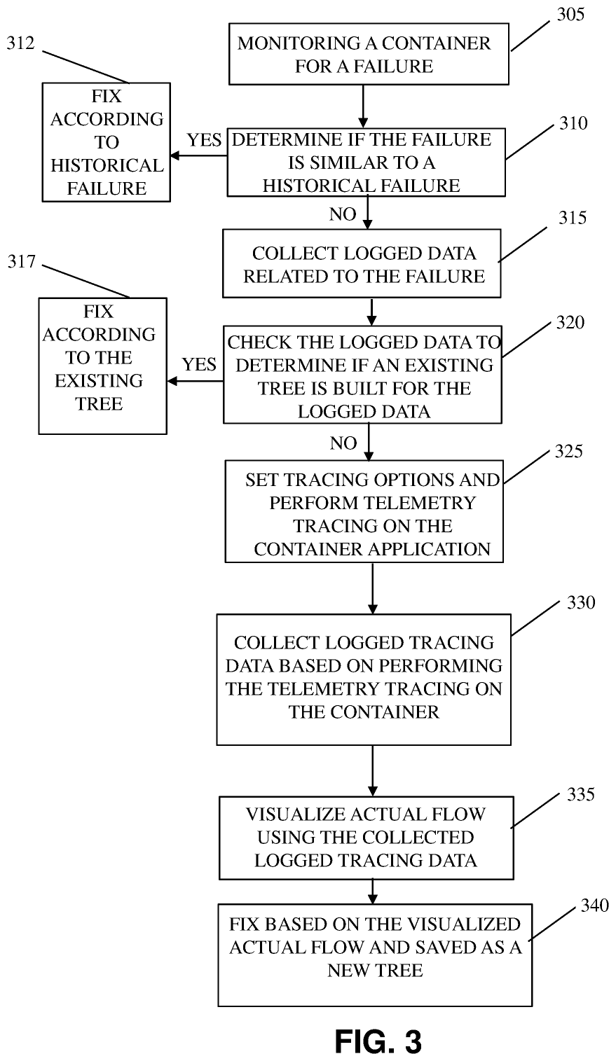

FIG. 3 shows a flowchart of an exemplary method of the debugging management server in accordance with aspects of the present invention. Steps of the method may be carried out in the environment of FIG. 2 and are described with reference to elements depicted in FIG. 2.

At step 305, the system monitors, at the monitoring agent module 218, the at least one microservice in the container 210 and determines that the at least one microservice has a failure. At step 310, the system determines, at the orchestration platform module 240, whether the at least one microservice crashing is similar to a historic failure. At step 312, the system fixes, at the orchestration platform module 240, the at least one microservice crashing by applying a similar solution of the historic failure in response to a determination that the at least one microservice crashing is similar to the historic failure. At step 315, the system collects, at the monitoring agent module 218, logged data related to the failure in response to a determination that the at least one microservice crashing is not similar to a historic failure. In embodiments, and as described with respect to FIG. 2, the monitoring agent module 218 sends the collected logged data to the collector module 220. In further embodiments, the collector module 220 sends the collected logged data to the log analyzer module 222.

At step 320, the system checks, at the log analyzer module 222, the logged data to determine if an existing tree is built for the collected logged data. At step 317, the system fixes, at the fixing module 230, the at least one microservice crashing by applying a similar fix of the existing tree to the at least one microservice crashing in response to a determination that the existing tree is built for the collected logged data. In embodiments, and as described with respect to FIG. 2, the log analyzer module 222 determines tracing options which are needed and sends the tracing options which are needed to the telemetry agent pool module 232 in response to a determination that an existing tree is not built for the collected logged data. The log analyzer module 222 also places a request on a suspected methods tracer module 224 to build a suspected methods tree using artificial intelligence (AI) in response to a determination that an existing tree is not built for the collected logged data. At step 325, the system sets, at the telemetry agent pool module 232, the tracing options based on the tracing options received from the log analyzer module 222. In embodiments and as described with respect to FIG. 2, the telemetry agent pool module 232 also performs telemetry tracing on the container 210 which includes a plurality of microservices (e.g., a first microservice 212) and collects data on at least one microservice (e.g., a first microservice 212) of the plurality of microservices. At step 330, the system collects, at the telemetry agent pool module 233, logged tracing data based on performing the telemetry tracing on the container. In embodiments and as described with respect to FIG. 2, the telemetry agent pool module 232 sends the collected data from the telemetry tracing to the collector module 220. The collector module 220 then sends the collected data from the telemetry tracing to the visualizer module 234.

At step 335, the system visualizes, at the visualizer module 234, an actual flow of data through a visualizer user interface (UI) over an exception stack corresponding to the collected data from the telemetry tracing to determine a root cause of the at least one microservice crashing. In embodiments and as described with respect to FIG. 2, the visualizer module 234 sends the root cause of the at least one microservice crashing to the fixing module 230. In particular, the visualizer module 234 visualizes the actual flow of data through the visualizer UI by correlating the actual flow of data over the exception stack corresponding to the collected data in a graphical representation and detecting data going wrong at particular nodes. At step 340, the system fixes, at the fixing module 230, the root cause of the at least one microservice crashing. In embodiments and as described with respect to FIG. 2, the fixing module 230 fixes the root cause of the least one microservice crashing by utilizing at least one of a code change, a configuration change, a work around, etc. The fixing module 230 then sends the root cause of the at least one microservice and the fix to the log analyzer module 222 for saving a tree in the knowledge base module 260.

FIG. 4 shows a block diagram of a log analyzer module in accordance with aspects of the present invention. In embodiments, the log analyzer module 222 comprises the suspected methods tracer module 224 and the code learner module 226. The log analyzer module 222 also communicates with a static code analysis tool module 250 and the knowledge base module 260.

In embodiments, the log analyzer module 222 builds knowledge in the knowledge base module 260 based on a methods to methods call, incoming and outgoing method calls, class information details, and all subsequent calls within the method required for a successful execution of any such methods. The log analyzer module 222 includes a suspected methods tracer module 224 which communicates with a static code analysis tool module 250 to exploit an abstract syntax tree (AST) parser application programming interfaces (APIs) to build a custom tree for exception tasks from an underlying compilation unit to understand the complete method calls and an implementation of the method calls.

In embodiments, the code learner module 226 walks through an exception stack of collected logged data and checks an existing tree within the knowledge base of the knowledge base module 260 to see whether the existing tree is built for the exception stack of the collected logged data. The fixing module 230 in FIG. 2 fixes the at least one microservice crashing by applying a similar fix of the existing tree to the at least one microservice crashing in response to a determination that the existing tree is built for the collected logged data.

In embodiments, the code learner module 226 places a request on the suspected methods tracer module 224 to build a suspected methods tree using artificial intelligence (AI) from the underlying compilation units of the exception stack in response to a determination that there is no existing tree built for the collected logged data. The suspected methods tracer module 224 builds the suspected methods tree to recreate a structure of all suspected methods that are potentially involved including dependent methods in response to the request being approved. The suspected methods tracer module 224 marks the methods that are out of scope in response to the request being denied. In particular, the suspected methods tracer module 224 builds the suspected methods tree recursively until an iteration is completed by utilizing artificial intelligence (AI), a class is reached which is out of scope, or returns to the original method and thereby completes iterations over the exception stack. In particular, the suspected methods tracer module 224 builds an entire tree related to a complete stack containing all built suspicious methods.

In embodiments, the suspected methods tracer module 224 transforms the suspected methods tree to open telemetry tags for the at least one telemetry agent described in FIG. 2. In particular, the suspected methods tracer module 224 transforms the suspected methods tree to open telemetry tags so that tracing options can be set to perform telemetry tracing on the container application by the at least one telemetry agent to collect logged tracing data. The collector module 222 in FIG. 2 receives the collected logged tracing data and sends the collected logged tracing data to the visualizer module 234. The visualizer module 234 visualizes an actual flow of data through a visualizer user interface (UI) over an exception stack corresponding to the collected data from the telemetry tracing to determine a root cause of the at least one microservice crashing. In particular, the visualizer module 234 visualizes the actual flow of data through the visualizer UI by correlating the actual flow of data over the exception stack corresponding to the collected data in a graphical representation and detecting data going wrong at particular nodes.

In embodiments, the log analyzer module 222 sets the tracing options to be in a high-performance mode in response to a frequency of an exception being set to be a high amount, so that only methods within the exception stack are identified to be traced. In other embodiments, the log analyzer module 222 sets the tracing options to be in a low-performance mode in response to a frequency of an exception being set to be a low amount, so that a comprehensive amount of data collection can be triggered and traced.

In embodiments, the suspected methods tracer module 224 determines that certain methods are outside of the scope of a repository and the code learner module 226 marks the certain methods to be recorded and sends the marked certain methods to an external entity. In the code learner module 226, the certain methods that are determined to be outside of the scope of the repository are skipped so that tracing is performed on methods within the scope of the repository.

In an exemplary use case, there is an exception in a thread “main” java.lang.NullPointerException as shown below:

| | |
|---|---|
| at Class1.main(Class1.java:25); | |
| at Class2.addOne(Class2.java:13); | |
| at ClassX.add(ClassX.java:13); | |
| at Class2.add(ClassX.java:9); | |
| at Class1.main(Class1.java: 19) | (Thread 1). |

In this use case, the code learner module 224 analyzes Thread 1 to mark the methods which are in scope and out of scope as shown below:

| | | |
|---|---|---|
| at Class1.main(Class1.java:25) | 1 | (in scope); |
| at Class2.addOne(Class2.java:13) | 1 | (in scope); |
| at ClassX.add(ClassX.java:13) | 0 | (out of scope); |
| at Class2.add(ClassX.java:9) | 1 | (in scope); |
| at Class1.main(Class1.java: 19) | 1 | (in scope) (Thread 1). |

In this use case, the code learner module 224 analyzes each method drawn to a tree to form a complete travel path of each method before a next scope method is called as shown below:

```
Class1 {
  Main( ) {
    Class6.init( );
      Class7.set( );
      Class2.add( )
}
  Class2 {
    Add( ) {
      Class8.init( );
      ClassX.add( );
    }
  }
```

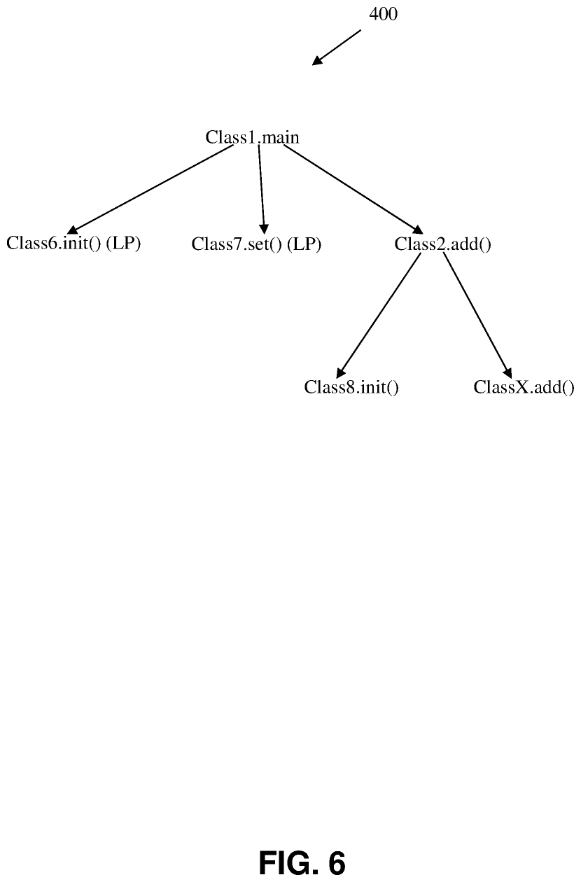

FIG. 6 shows a tree diagram of the log analyzer in accordance with aspects of the present invention. In particular, the tree diagram 400 of the log analyzer comprises classes (e.g., Class1, Class2, Class6, Class7, Class8, and ClassX) and functions (init( ), set( ), add( ), init( ), and add( ). In FIG. 6, LP corresponds with a low-performance mode. In embodiments, the tree diagram 400 corresponds with the complete travel path of this use case discussed above.

In embodiments, the log analyzer module 222 sets the tracing options of the tree diagram 400 to be in the low-performance mode. In embodiments, the orchestration platform module 240 sets the frequency of the exception in the low-performance mode.

In embodiments, the suspected methods tracer module 224 uses a checkException method to check for a given exception within a method in a corresponding class to make corresponding and a minimal classes required for tracing. The checkException method mocks methods which are not directly involved in a NullPointerException (NPE) stack. In further embodiments, the suspected methods tracer module 224 uses a traceMethod( ), to loop over a stack to identify and mark respective classes for tracing. The traceMethod( ), mocks methods which are not directly involved in the NPE stack. In embodiments, the suspected methods tracer module 224 uses a getProcessedMethods( ), to get a list of all methods which need to be traced by the at least one agent.

The suspected methods tracer module 224 implements an example program that showcases an arithmetic exception as shown below:

| | |
|---|---|
| 1 | package mypackage; |
| 2 | |
| 3 | import java.io.*; |
| 4 | |
| 5 | class A { |
| 6 | int x; |
| 7 | A(int x) { |
| 8 | this.x = x; |
| 9 | |
| 10 | } |
| 11 | } |
| 12 | |
| 13 | class B { |
| 14 | int y; |
| 15 | A a; |
| 16 | B(int y, A a) { |
| 17 | this.y = y; |
| 18 | this.a = a; |
| 19 | } |
| 20 | } |
| 21 | |
| 22 | class C { |
| 23 | int z; |
| 24 | C(int z) { |
| 25 | this.z = z; |
| 26 | |
| 27 | } |
| 28 | } |
| 29 | |
| 30 | class D { |
| 31 | int w; |
| 32 | B b; |
| 33 | C c; |
| 34 | D(B b, C c) { |
| 35 | this.b = b; |
| 36 | this.c = c; |
| 37 | } |
| 38 | |
| 39 | public int divide( ){ |
| 40 | setMethod(0); //This method sets the value to zero |
| 41 | w = this.b.y / this.b.a.x; //fails here |
| 42 | return w; |
| 43 | } |
| 44 | |
| 45 | public void setMethod(int a) { |
| 46 | this.b.a.x = a; |
| 47 | } |
| 48 | |
| 49 | public int sub( ){ |
| 50 | w = this.b.y − this.c.z; |
| 51 | return w; |
| 52 | } |
| 53 | |
| 54 | |
| 55 | } |
| 56 | |
| 57 | class Main { |
| 58 | public static void main(String args[ ]) { |
| 59 | |
| 60 | Aa = new A(10); |
| 61 | Bb = new B(10, a); |
| 62 | Cc = new C(5); |
| 63 | Dd = new D(b, c); |
| 64 | System.out.println(″sub: ″+d.sub( )); |
| 65 | System.out.println(″add: ″+d.divide( )); |
| 66 | |
| 67 | } |
| 68 | } |
| | (Example Program 1). |

In embodiments, when the suspected methods tracer module 224 executes the above example program 1, the output is shown below:

```
~ % java mypackage.Main
sub: 5
Exception in thread ″main″ java.lang.ArithmeticException: / by zero
    at mypackage.D.divide(Main.java:41)
        at mypackage.Main.main(Main.java:65)
                                                    (Output of Example Program 1).
```

In the output of the example program 1, while sub( ), method in line number 64 executes successfully with the result, divide( ), method in line number 65 fails with a arithmetic exception. The root cause of the arithmetic exception is division by zero and the cause of where exactly the divisor was set to zero is not evident from the exception stack.

In embodiments, the suspected methods tracer module 224 implements functions across different microservices. In this scenario, the suspected methods tracer module 224 detects potential methods which can contribute to a failure and trace only those methods which may be associated with a failure instead of performing telemetry tracing across all microservices.

In embodiments, the log analyzer module 222 receives an input below (i.e., Exception Stack 1):

```
Exception in thread ″main″ java.lang.ArithmeticException: / by zero
    at mypackage.D.divide(Main.java:41)
  at mypackage.Main.main(Main.java:65)
                                                    (Exception Stack 1).
```

In embodiments, the log analyzer module 222 sends an output below:
mypackage.Main [main]; mypackage.D [d,divide,setMethod].

### (Output of Exception Stack 1).

In embodiments, the log analyzer module 222 sends the output above as an input value for an open telemetry property which can do customized tracing as shown below:
System Property: otel.instrumentation.methods.include;
Environment variable: OTEL_INSTRUMENTATION_METHODS_INCLUDE.

In embodiments, the suspected methods tracer module 224 creates an abstract syntax tree (AST) as shown below:

```
List <String> methodTags = new ArrayList <Strings>
  Init ( ) {
  Parser parser = new ASTParser ( );
  Parser.createASTs (paths, FileASTRequester (Path path, CompilationUnit cu) {
    Map.put(path,extractQualifuedName ( ), cu);
}
                                        (Creation of AST).
```

In embodiments, the suspected methods tracer module 224 also creates a process method, a process node, and a new AST Tree as shown below:

```
Public processMethod (Class c, method m) {
CompilationUnit cu = map.get (c.getQualifiedName ( ) );
processNode (cu, method);
}
Public processNode (CompilationUnit cu, Method m) {
      Cu.accept (New ASTVisitor( ) {
    @Override;
    public boolean visit (MethodDeclaration node) {
      if (node, getName == m) {
        methodTags.append (methodname.getClass ( ) + “_” + node,getName( ));
        buildASTTree (node) // build a new ASTTree with MethodInvocations
        }
        getChildren ( ).foreach (child -> {
        if (child.getType == Type.METHOD_DECLARATION)
            child.getClass( ).getQualifiedName ( );
            processMethod(child.getClass ( ), child.getName ( ) );
        }
    }
}
Return methodTags;
}
```

In embodiments, the code learner module 224 walks through the stack exception and checks if an existing tree exists. In further embodiments, the code learning module 224 generates open telemetry tags (OTEL tags) for at least one agent as shown below:

```
if (checkIfTreeisAlreadyBuilt (log)) {
        createSimilarStackEvent (log) ;
} else {
apply Agent (generateOTELTags (log) )
}
}
Public String generateOTELTags (log) {
}
  List<Statement> statements = extractStatement (log);
    Foreach statement : statements {
      Class cName = extractClass (statement);
      Method method = extractMethod (statement);
        List <String> methodTags =
                    Engine.processMethod(cName, method);
        CreateOTELTags (methodTags);
}
} (Generation of OTEL Tags).
```

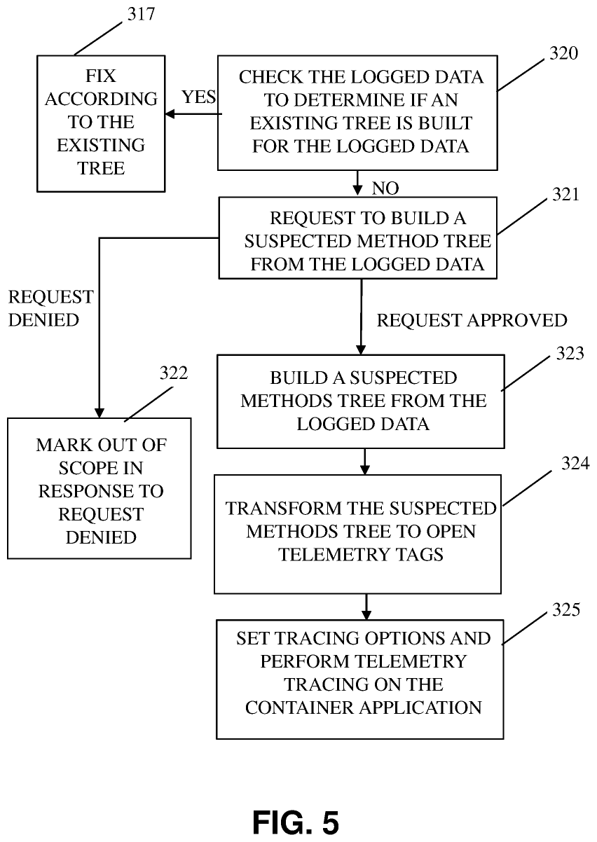

FIG. 5 shows a flowchart of an exemplary method of the log analyzer in accordance with aspects of the present invention. Steps of the method may be carried out in the environment of FIG. 4 and are described with reference to elements depicted in FIG. 4. In embodiments, the steps 317, 320, and 325 in FIG. 5 are similar to the steps in FIG. 3.

In embodiments, at step 320, the system checks, at the code learner module 226, the collected logged data to determine if an existing tree is built for the collected logged data. At step 317, the system fixes, at the fixing module 230, the at least one microservice crashing by applying a similar fix of the existing tree to the at least one microservice crashing in response to a determination that the existing tree is built for the collected logged data. In embodiments, and as described with respect to FIG. 4, the log analyzer module 222 determines tracing options which are needed and sends the tracing options which are needed to the telemetry agent pool module 232 in response to a determination that an existing tree is not built for the collected logged data.

In embodiments, at step 321, the system places, at the suspected methods tracer module 224, a request to build a suspected methods tree using artificial intelligence (AI) from the underlying compilation units of the exception stack in response to a determination that there is no existing tree built for the collected logged data. At step 322, the system marks, at the suspected methods tracer module 224, an out of scope in response to the request to build the suspected methods tree from the underlying compilation units of the exception stack being denied.

In embodiments, at step 323, the system builds, at the suspected methods tracer module 224, the suspected methods tree using artificial intelligence (AI) to recreate a structure of all suspected methods that are potentially involved including dependent methods in response to the request being approved. At step 324, the system transforms, at the suspected methods tracer module 224, the suspected methods tree to open telemetry tags so that tracing options can be set to perform telemetry tracing on the container application by the at least one telemetry agent to collect logged tracing data. At step 325, the system sets, at the telemetry agent pool module 232, the tracing options based on the tracing options received from the log analyzer module 222.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
monitoring, by a processor set, at least one microservice within a container for a failure;
collecting, by the processor set, logged data in response to the at least one microservice having the failure;
checking, by the processor set, the logged data to determine that an existing tree is not built for the logged data;
performing, by the processor set, telemetry tracing on the at least one microservice in response to the existing tree not being built for the logged data;
collecting, by the processor set, logged tracing data based on performing the telemetry tracing on the at least one microservice;
visualizing, by the processor set, an actual flow of the collected logged tracing data; and
fixing, by the processor set, the at least one microservice on the visualized actual flow of the collected logged tracing data.

2. The computer-implemented method of claim 1, further comprising:
determining that the failure is similar to a historical failure; and
fixing the at least one microservice according to the historical failure.

3. The computer-implemented method of claim 1, further comprising:
determining that the existing tree is built for the logged data; and
fixing the at least one microservice according to the existing tree.

4. The computer-implemented method of claim 1, further comprising:
building a suspected methods tree from the logged data; and
transforming the suspected methods tree to open telemetry tags.

5. The computer-implemented method of claim 4, further comprising setting tracing options for the telemetry tracing according to the open telemetry tags.

6. The computer-implemented method of claim 1, wherein the failure comprises a functional exception.

7. The computer-implemented method of claim 1, wherein the failure comprises a logical error.

8. The computer-implemented method of claim 1, wherein the actual flow of the collected logged tracing data is visualized through a user interface (UI).

9. The computer-implemented method of claim 1, wherein the at least one microservice is contained in a cloud-based system.

10. The computer-implemented method of claim 1, wherein the collected logged tracing data is a subset of data corresponding to the at least one microservice.

11. The computer-implemented method of claim 1, wherein the existing tree comprises a historical tree which corresponds with a previous failure of a previous microservice.

12. A computer program product comprising one or more computer readable storage media having program instructions collectively stored on the one or more computer readable storage media, the program instructions executable to:
monitor at least one microservice within a container for a failure;
collect logged data in response to the at least one microservice having the failure;
check the logged data to determine that an existing tree is not built for the logged data;
perform telemetry tracing on the at least one microservice in response to the existing tree not being built for the logged data;
collect logged tracing data based on performing the telemetry tracing on the at least one microservice;
visualize an actual flow of the collected logged tracing data; and
fix the at least one microservice on the visualized actual flow of the collected logged tracing data.

13. The computer program product of claim 12, further comprising:
determining that the failure is similar to a historical failure; and
fixing the at least one microservice according to the historical failure.

14. The computer program product of claim 12, further comprising:
determining that the existing tree is built for the logged data; and
fixing the at least one microservice according to the existing tree.

15. The computer program product of claim 12, further comprising:
building a suspected methods tree from the logged data; and
transforming the suspected methods tree to open telemetry tags.

16. The computer program product of claim 15, further comprising setting tracing options for the telemetry tracing according to the open telemetry tags.

17. A system comprising:
a processor set, one or more computer readable storage media, and program instructions collectively stored on the one or more computer readable storage media, the program instructions executable to:
monitor at least one microservice within a container for a failure;
collect logged data in response to the at least one microservice having the failure;
check the logged data to determine that an existing tree is not built for the logged data;
perform telemetry tracing on the at least one microservice in response to the existing tree not being built for the logged data;
collect logged tracing data based on performing the telemetry tracing on the at least one microservice;
visualize an actual flow of the collected logged tracing data; and
fix the at least one microservice based on the visualized actual flow of the collected logged tracing data,
wherein the existing tree comprises a historical tree which corresponds with a previous failure of a previous microservice.

18. The system of claim 17, wherein the failure comprises a functional exception.

19. The system of claim 17, wherein the failure comprises a logical error

20. The system of claim 17, wherein the actual flow of the collected logged tracing data is visualized through a user interface (UI).
